(19) United States
(12) Patent Application Publication
(10) Pub. No.: US 2025/0020611 A1
(43) Pub. Date: Jan. 16, 2025

(54) HIGH THROUGHPUT ELECTROCHEMICAL EXPERIMENTATION DEVICES AND METHODS

(71) Applicant: The Johns Hopkins University, Baltimore, MD (US)

(72) Inventors: Nicholas G. Pavlopoulos, Columbia, MD (US); Diarny O. Fernandes, Laurel, MD (US)

(21) Appl. No.: 18/768,619

(22) Filed: Jul. 10, 2024

Related U.S. Application Data
(60) Provisional application No. 63/512,938, filed on Jul. 11, 2023.

(51) Int. Cl. G01N 27/28; G01N 27/30; G01N 27/403

(52) U.S. Cl. CPC G01N 27/283; G01N 27/30; G01N 27/403

(57) ABSTRACT

Disclosed herein is a device for electrochemical experimentation comprising a reaction well holder, a gasket, and a top plate. The reaction well holder is comprised of a plurality of reaction wells, electrodes, and electrical contacts. The gasket and top plate are attached in such a fashion that each reaction well is sealed in an air-tight fashion. Once assembled this device can be mounted on a potentiostat of electrochemical experimentation can be carried out under an inert atmosphere and each reaction well may be sampled without the disassembly of the device.

### CROSS-REFERENCE TO RELATED APPLICATIONS

This application is related to U.S. Provisional Application No. 63/512,938, filed Jul. 11, 2023, the contents of which is incorporated by reference herein in its entirety.

### BACKGROUND OF THE INVENTION

Catalysts are broadly employed in the chemical industry to enable chemical transformations to run more efficiently and access new chemical transformations that were not previously possible. Specifically, catalysts are critical for the formation of feedstock chemicals and fuels such as, for example, hydrogen, methanol, and ammonia. Moreover, catalysts are utilized in the formation of every day products such as, for example, the production of various types of polymers.

### SUMMARY OF THE INVENTION

To meet the demand for new catalysts, the inventors have now developed a device for electrochemical experimentation comprising: a reaction well holder having a top surface and a bottom surface opposite the top surface, the reaction well holder comprising: a plurality of reaction wells, each reaction well having an opening in the top surface of the reaction well holder and a bottom surface between the top surface and the bottom surface of the reaction well holder; a plurality of electrodes in the reaction wells, each reaction well comprising two or more of the electrodes located on an interior side of the bottom surface of each reaction well; and a plurality of electrical contacts located on the bottom surface of the reaction well holder, wherein, for each reaction well, two or more of the electrical contacts are in electrical communication with the two or more of the electrodes of the reaction well; a gasket positioned on the top surface of the reaction well holder and covering the openings of the reaction wells; and a top plate positioned on top of the gasket and fastened to the reaction well holder to create an airtight seal for the reaction wells.

Another embodiment includes a system for electrochemical analysis comprising: an exemplary embodiment of a device for electrochemical experimentation as discussed herein; and a potentiostat.

Another embodiment includes a method from electrochemical experimentation comprising: loading each of a plurality of reaction wells in a reaction well holder with a substrate, a catalyst, a binder, an electrolyte, and a solvent; covering the plurality of reaction wells with a gasket; fastening a top plate on top of the gasket to form a seal such that each reaction well is air-tight; mounting the reaction well holder on a potentiostat, the potentiostat being in electrical contact with the plurality of reaction wells of the reaction well holder; subjecting the plurality of reaction wells to electrolysis using the potentiostat; and sampling the plurality of reaction wells.

### BRIEF DESCRIPTIONS OF THE DRAWINGS

FIG. 1 depicts an example device for electrochemical experimentation in an exploded format according to one or more embodiments described herein.

FIGS. 2A-2D depict an assembled example device for electrochemical experimentation according to one or more embodiments described herein.

FIGS. 3A-3B depict portions of a disassembled example device for electrochemical experimentation according to one or more embodiments described herein.

FIGS. 4A-4B depict example electrodes for an example device for electrochemical experimentation according to one or more embodiments described herein.

FIG. 5 depicts example electrical contacts for an example device for electrical experimentation according to one or more embodiment described herein.

FIGS. 6A-6C depict an example alignment member for an example device for electrochemical experimentation according to one or more embodiments described herein.

FIGS. 7A-B depict an exemplary configuration of an example alignment member with a potentiostat for an example device for electrochemical experimentation according to one or more embodiments described herein.

FIG. 8 depicts an example method for electrochemical experimentation according to one or more embodiments described herein.

FIG. 9 depicts an example flowchart for a method for electrochemical experimentation and analysis according to one or more embodiments described herein.

### DETAILED DESCRIPTION OF THE EMBODIMENTS

As recognized by the inventors, there is a need for methods to quickly access new and efficient catalysts. Moreover, there is a need to develop new catalysts to access new feedstock chemicals and develop novel materials.

As recognized by the inventors, catalytic reactions are critical to the preparation of fuels and many other industrially relevant processes. These reactions employ a catalyst to enable these transformations while minimizing the energy required to perform such a reaction. The catalysts in these reactions may perform redox processes to facilitate a specific chemical transformation. As employed by the inventors, electrochemistry provides an environmentally friendly alternative to these traditional redox reactions by eliminating the need for stoichiometric oxidants or reductants. Moreover, the redox potentials can be precisely tuned for a specific catalyst or transformation to limit undesired byproducts in a reaction. Additionally, if desired, the current used in the electrochemistry can be controlled to afford control over the rate of the reaction.

As recognized by the inventors, electrochemical reactions may be limited in that they require the use of at least two electrodes, typically three electrodes, to flow electricity through the reaction solvent and perform the desired reaction. Conventional electrochemical reactions may require the use of bulky metal rods that are inserted into the reaction solvent and attached to a potentiostat using bulky clamps and wires. The necessity of incorporating these components inherently limits the use of electrochemistry in an inert atmosphere, because the positioning and connectivity of the electrodes must be considered in the reaction setup. Additionally, the need for these components limits the ability for electrochemical reactions to be miniaturized and has limited the use of electrochemistry in high-throughput experimentation.

One or more embodiments of the present invention described herein include an exemplary device for performing electrochemical reactions both in a miniaturized, high-throughput format and under an inert atmosphere. This novel invention overcomes present limitations in electrochemistry by enabling electrochemical reactions to be performed on a microscale while also being performed under an inert atmosphere. Moreover, the novel design of the exemplary device provides access for each reaction well to be sampled and analyzed without the need for disassembly of the exemplary device.

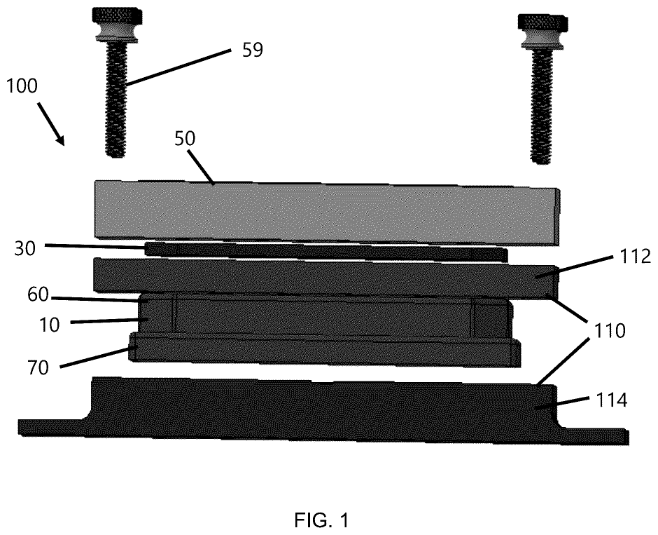

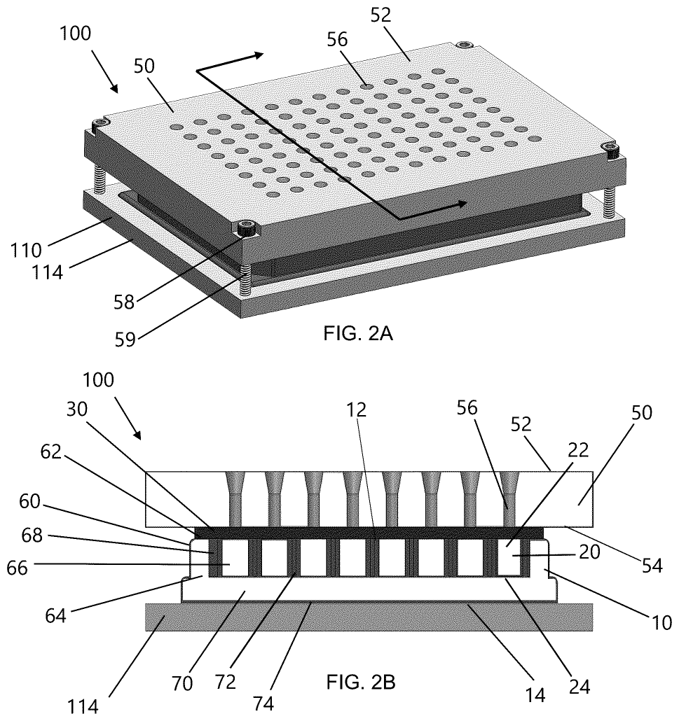

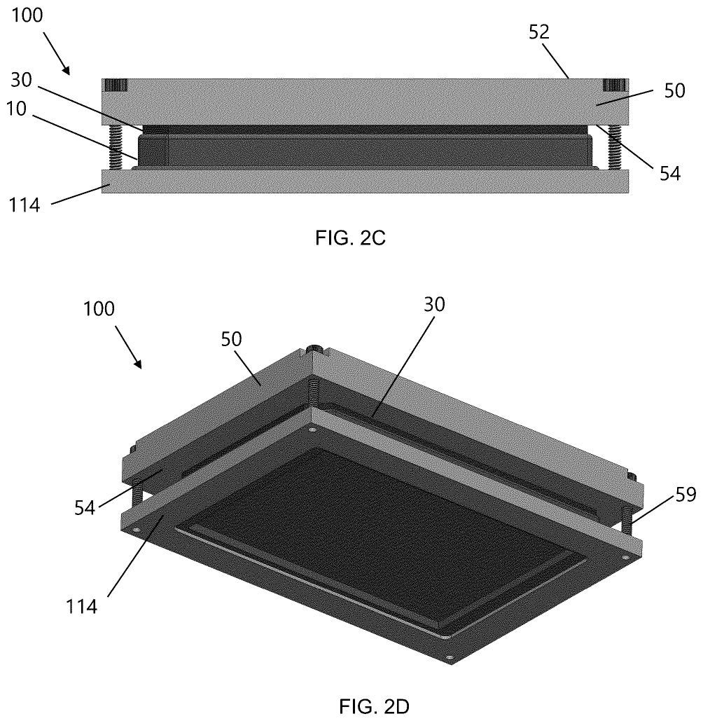

FIG. 1 depicts an example device 100 in an exploded format according to one or more embodiments described herein. FIGS. 2A-2D depict the assembled example device 100 for electrochemical experimentation according to one or more embodiments described herein. FIG. 2B is cross-section of the assembled example device 100 along line 2B-2B in FIG. 2A. FIGS. 3A-3B depict portions of the disassembled example device 100 for electrochemical experimentation according to one or more embodiments described herein.

In exemplary embodiments, the device 100 may comprise a reaction well holder 10, a gasket 30, and a top plate 50. The reaction well holder 10 may comprise a plurality of reaction wells 20. In exemplary embodiments, the reaction well holder 10 may include at least 40 reaction wells and at most 250 reaction wells. As an example, the reaction well holder 10 in FIG. 3A includes 96 reaction wells 20. Each reaction well 20 may have an opening 22 in a top surface 12 of the reaction well holder 10 and a bottom surface 24 between the top surface 12 and a bottom surface 14 of the reaction well holder 10. In exemplary embodiments, the reaction wells 20 may be cylindrical in shape. In exemplary embodiments, each reaction well 20 may have a volume of at least 0.2 milliliters and at most 5.0 milliliters. In exemplary embodiments, each reaction well 20 may have a depth from the opening 22 of the reaction well 20 to the bottom surface 24 of the reaction well 20 of at least 0.5 centimeters and at most 2.5 centimeters. In exemplary embodiments, the opening 22 of each reaction well 20 may have an area of at least 0.7 square centimeters to at most 4.0 square centimeters.

In some embodiments, the reaction well holder 10 may further comprise an upper portion 60 and a lower portion 70. In exemplary embodiments, the upper portion 60 has a top surface 62 and a bottom surface 64 opposite the top surface 62. In some embodiments, the top surface 62 of the upper portion 60 is the top surface 12 of the reaction well holder 10. The upper portion 60 may further comprise a plurality of through holes 66 corresponding to the openings 22 and interior side walls 68 of the reaction wells. In exemplary embodiments, the lower portion 70 has a top surface 72 and a bottom surface 74 opposite the top surface 72. In some embodiments, the bottom surface 74 of the lower portion 70 is the bottom surface 14 of the reaction well holder 10. In some embodiments, the top surface 72 of the lower portion 70 may comprise a plurality of electrodes in each of the reaction wells 20. In exemplary embodiments, the electrodes are screen printed on the top surface 72 of the lower portion 70 of the reaction well holder 10. In some embodiments, the lower portion 70 of the reaction well holder 10 and the upper portion 60 of the reaction well holder 10 are, for example, melded, glued, and/or snug fit to form the reaction well holder 10. In exemplary embodiments, the reaction well holder further 10 comprises a plurality of alignment indicators to align the upper portion 60 and the lower portion 70 during assembly.

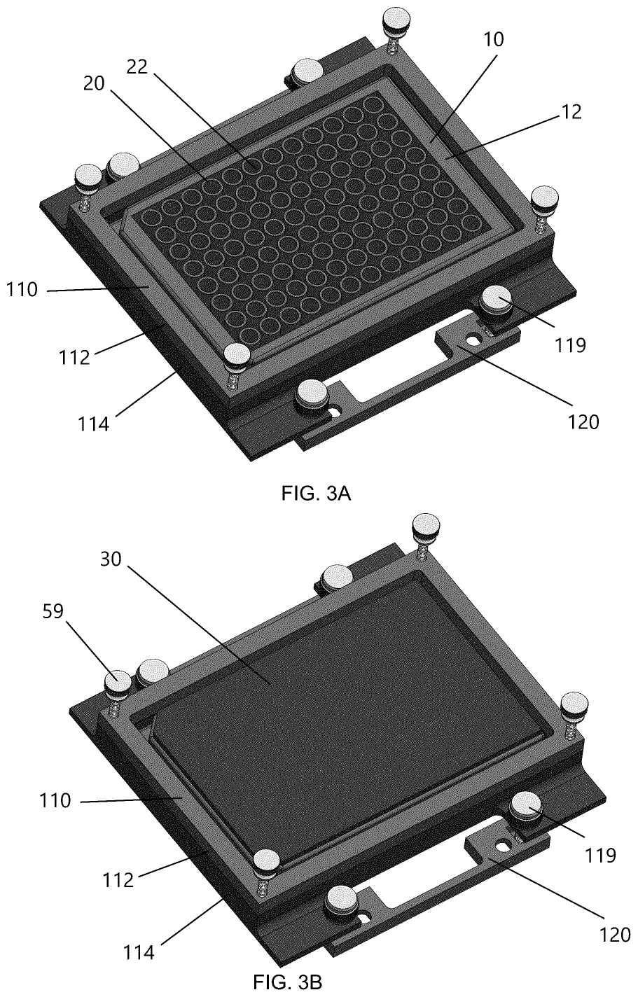

FIGS. 4A-4B depict example electrodes for an example device 100 for electrochemical experimentation according to one or more embodiments described herein. FIG. 4B is an expanded view of portion 4B in FIG. 4A. Each reaction well 20 of the reaction well holder 10 may further comprise a plurality of electrodes 80 in the reaction wells 20 located on the interior side of the bottom surface 24 of each reaction well 20. In some embodiments, each reaction well 20 may contain two or more electrodes 80 on the interior side of the bottom surface 24 of each reaction well 20. In exemplary embodiments, each reaction well 20 contains three electrodes 80 located on the interior bottom surface 24 of each reaction well 20. The three electrodes 80 may be a working electrode 84, a counter electrode 82, and a reference electrode 86. In some embodiments, the electrodes 80 are screen-printed electrodes. The electrodes 80 may have various shapes. In some embodiments, the electrodes 80 may be circular, semi-circular or ovular. In other embodiments, the electrodes 80 may be square. In exemplary embodiments, the electrodes 80 are circular or semi-circular. In some embodiments, the electrodes 80 may be selected from a carbon based electrode, a gold electrode, a platinum electrode, a silver electrode, and a lithium electrode. As an example, reference electrode 86 may be a silver-silver chloride electrode.

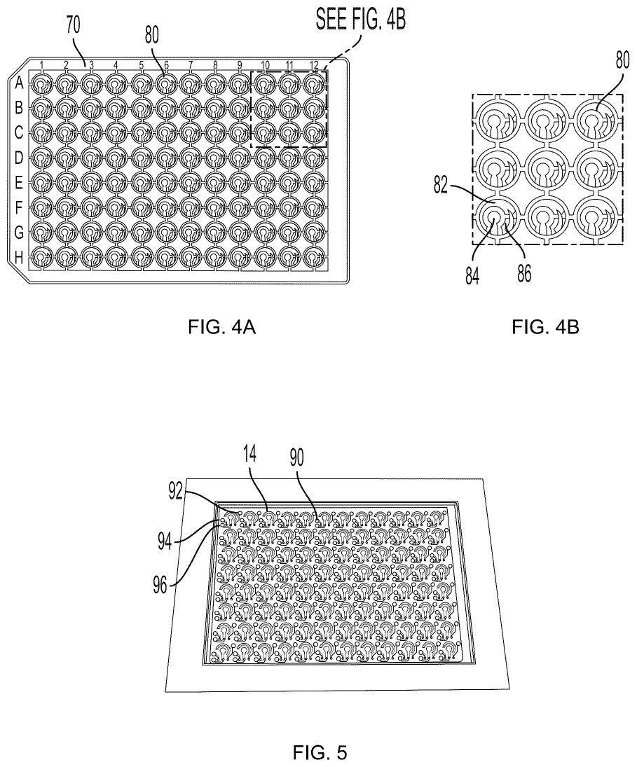

FIG. 5 depicts example electrical contacts for an example device 100 for electrical experimentation according to one or more embodiment described herein. Each reaction well 20 may further contain a plurality of electrical contacts 90 located on the bottom surface 14 of the reaction well holder 10. In some embodiments, each reaction well 20 may contain two or more electrical contacts 90 on the bottom surface 14 of the reaction well holder 10. As an example, for each reaction well 20, the electrical contacts 90 are in electrical communication with the electrodes 80 located on the interior bottom surface 24 of the reaction well 20. In exemplary embodiments, each reaction well 20 contains three electrical contacts 92, 94, 96 on the bottom surface 14 of the reaction well holder 10. In an exemplary embodiment, three electrical contacts 90 located on the bottom surface 14 of the reaction well holder 10 are in electrical contact with three electrodes 80 located on the interior surface of the reaction well 20. In an exemplary embodiment, the electrical contacts 90 on the bottom surface 14 of the reaction well holder 10 correspond to electrical contacts on a potentiostat.

As shown in FIG. 1 and FIG. 3B, for example, an example gasket 30 is depicted for the example device 100 for electrochemical experimentation according to one or more embodiments described herein. In exemplary embodiments, the gasket 30 is positioned on the top surface 12 of the reaction well holder 10 to cover the openings 22 of the reaction wells 20. The gasket 30 may cover all, some, or at least one of the reaction wells 20. As depicted in FIG. 3B, the gasket 30 covers all of the reaction wells 20. In exemplary embodiments, the gasket 30 serves to isolate each reaction well 20 from particulates or solvents that may splash or bubble during the course of a reaction. In exemplary embodiments, the gasket 30 may be sealed to create an air-tight environment for each reaction well 20 to prevent gases from entering the reaction well 20 and gaseous reagents or products from escaping the reaction well 20. In exemplary embodiments, the gasket 30 may isolate a reaction in one reaction well 20 from a reaction in another reaction well 20. In exemplary embodiments, the gasket 30 may be a penetrable material. In exemplary embodiments, the gasket 30 is a silicone rubber gasket. In exemplary embodiments, the gasket 30 may be pierced with a sampling device to obtain a reaction sample from a reaction well 20. For example, a gaseous reaction sample may be obtained from the gaseous headspace of the reaction well 20. For example, a reaction sample may be obtained from the solution within the reaction well 20. In some embodiments, the gasket may be reusable.

As shown in FIG. 1 and FIGS. 2A-D, for example, the device 100 for electrochemical experimentation may further comprise the top plate 50 positioned on top of the gasket 30. The top plate 50 may have a top surface 52 and a bottom surface 54 opposite the top surface 52. The bottom surface 54 of the top plate 50 may face the gasket 30. In exemplary embodiments, the top plate 50 may comprise a plurality of through holes 56. The through holes 56 may extend from the top surface 52 to the bottom surface 54 of the top plate 50. The through holes 56 may be aligned with the openings 22 of the reaction wells 20. In some embodiments, the through holes 56 may be circular, ovular, or square in cross-section. In exemplary embodiments, the through holes 56 are of a size such that a sampling device may reach and penetrate the gasket 30 to sample each reaction well 20 without removal of the top plate 50.

In some embodiments, the top plate 50 may be fastened to the reaction well holder 10 to seal each reaction well 20. In exemplary embodiments, the seal is air-tight. The top plate 50 may be a plastic or metal material. In exemplary embodiments, the top plate 50 is a stainless steel plate. In some embodiments, the top plate 50 may be a solid plate with one or more holes 58 for fastening. In some embodiments, the top plate 50 may be fastened to alignment member 110 by one or more fasteners 59 situation through corresponding holes 58 (for example, four fasteners 59 are depicted being situate through four holes 58 in FIG. 2A). In some embodiments, the top plate 50 may be fastened to the alignment member 110, and the reaction well holder 10 may be sandwiched between the top plate 50 and the alignment member 110, thereby providing an air-tight seal between the top plate 50 and the reaction well holder 10. In some embodiments, the top plate may be fastened to the reaction well holder 10 by one or more fasteners 59. In exemplary embodiments, the top plate 50 is fastened to the reaction well holder 10 by four fasteners 59. In some embodiments, the fasteners 59 may be screws, bolts, or clamps. In exemplary embodiments, the top plate 50 is fastened to the reaction well holder 10 with screws.

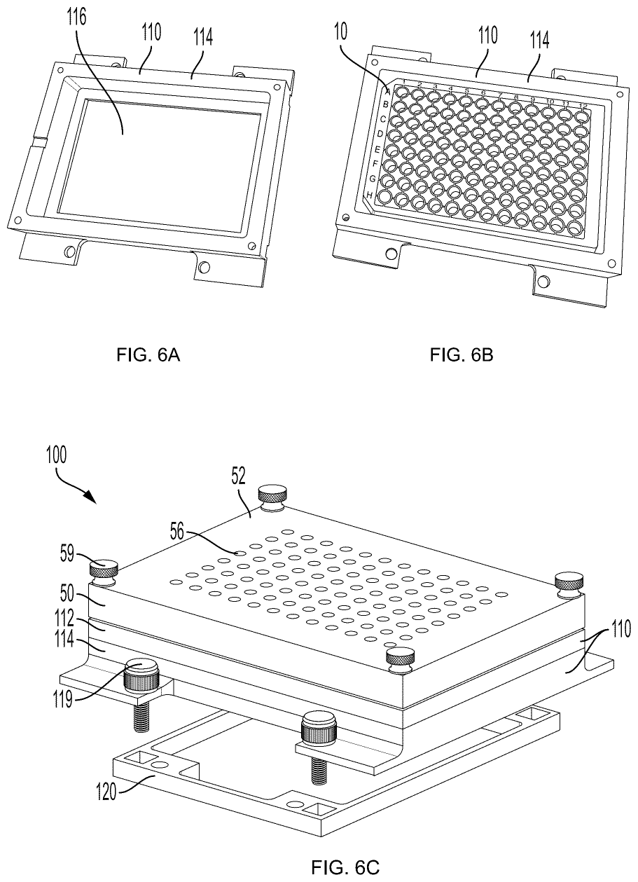

FIG. 1, FIG. 3A and FIGS. 6A-6C depict an example alignment member 110 for the example device 100 for electrochemical experimentation according to one or more embodiments described herein. The alignment member 110 may include an upper alignment member 112 and a lower alignment member 114. In some embodiments, the alignment member 110 may be comprised of two or more portions or may be a unitary body. In some embodiments, the alignment member 110 may be used to hold the device 100 in place and align the electrical contacts 80 on the bottom surface 14 of the reaction well holder 10 with a corresponding plurality of electrical contacts on a potentiostat. In some embodiments, the alignment member 110 is an alignment ring configured to fit snugly around a perimeter of the reaction well holder 10, as depicted in, for example FIG. 3A and FIG. 6B. In some embodiments, the alignment member 110 has an open interior 116 to receive the reaction well holder 10. In exemplary embodiments, the open interior 116 the alignment member 110 of has an area of at least 50 square centimeters and at most 200 square centimeters. In some embodiments, the alignment member 110 may be fastened to the reaction well holder 10. In exemplary embodiments, as depicted in FIG. 6C, the device 100 may be held together in a tight fight using fasteners 59. In exemplary embodiments, the alignment member 110 is integrated in the reaction well holder 10 as a unitary body (not shown). In some embodiments, the alignment member 110 may be made of a metal (e.g., aluminum, stainless steel, or titanium). In exemplary embodiments, the alignment member 110 is made of a stainless steel or hard plastic.

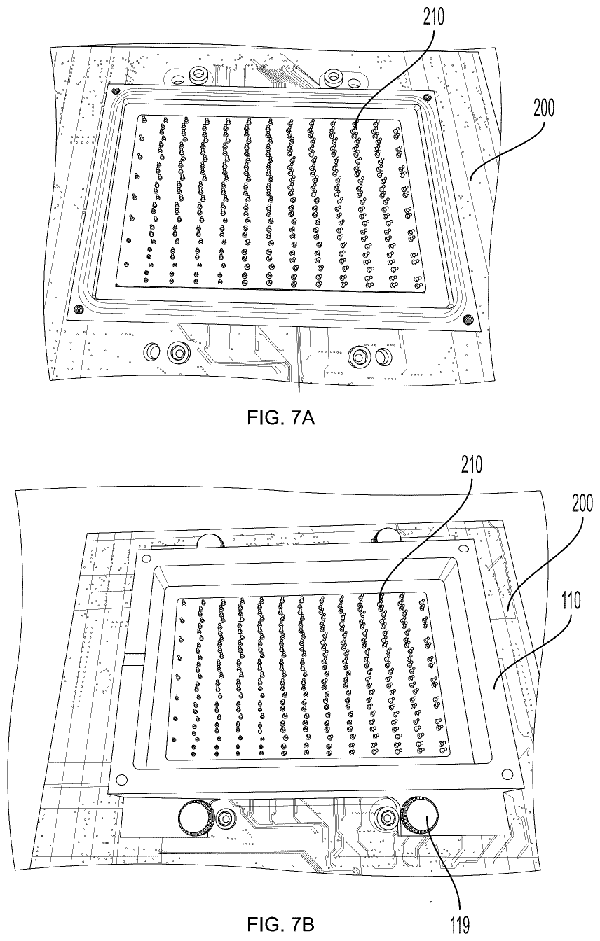

FIGS. 7A-B depict an exemplary configuration of the example alignment member 110 with a potentiostat 200 for an example device 10 for electrochemical experimentation according to one or more embodiments described herein. The alignment member 110 may be used to ensure the electrical contacts 210 of the potentiostat 200 properly align and sufficiently contact the electrical contacts 90 on the bottom surface 14 of the reaction well holder 10. In some embodiments, the alignment member 110 may be fastened to the potentiostat 200. In FIG. 7B, for ease of explanation, only the alignment member 110, and not the rest of the device 100, is depicted as being fastened to the potentiostat 200. In some embodiments, the alignment member 110 may be fastened to the potentiostat 200 with four or more fasteners 119. In exemplary embodiments, the alignment member 110 is fastened to the potentiostat 200 with four fasteners 119. In some embodiments, the fasteners may be screws, bolts, or clamps. In exemplary embodiments, the alignment member 110 is fasted to the potentiostat with four screws. In exemplary embodiments, the alignment member 110 may be secured to the potentiostat 200 using a supplementary alignment member 120, such as depicted in FIGS. 3A, 3B, and 6C. In exemplary embodiments, the supplementary alignment member 120 may be separate from or integral with the alignment member 110.

In exemplary embodiments, a system for electrochemical analysis may comprise the device 100 for electrochemical experimentation described herein and the potentiostat. In some embodiments, the system for electrochemical analysis can be used to study the electrochemical profile of a given reaction or catalyst. In some embodiments, the electrochemical analysis comprises at least one of potentiometry, coulometry, and voltammetry. In some embodiments, analytical techniques may be used as part of the electrochemical analysis, and exemplary analytical techniques may comprise at least one of cyclic voltammetry, linear sweep voltammetry, differential pulse voltammetry, chronoamperometry, or chronopotentiometry.

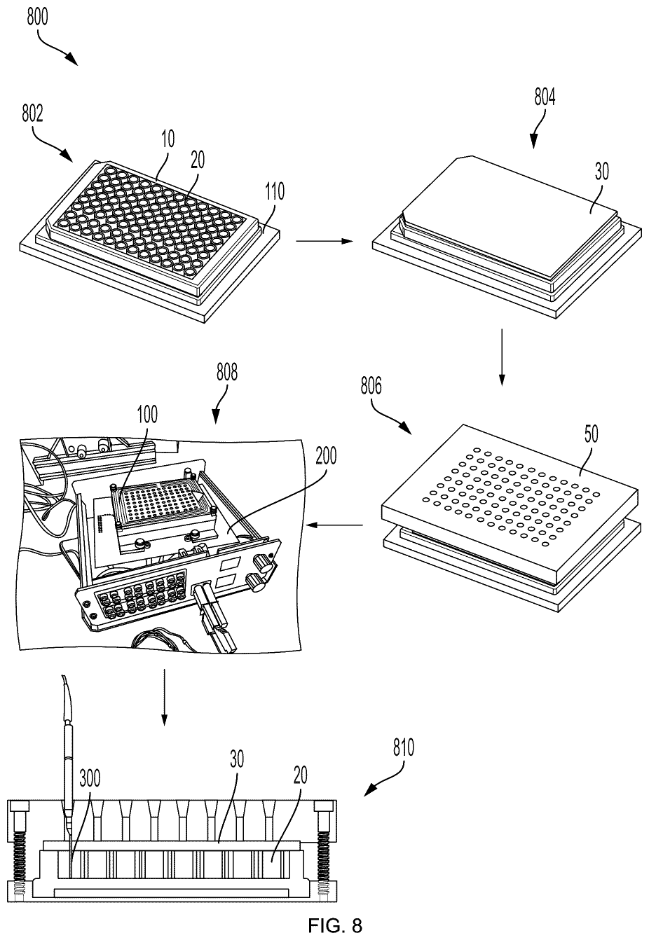

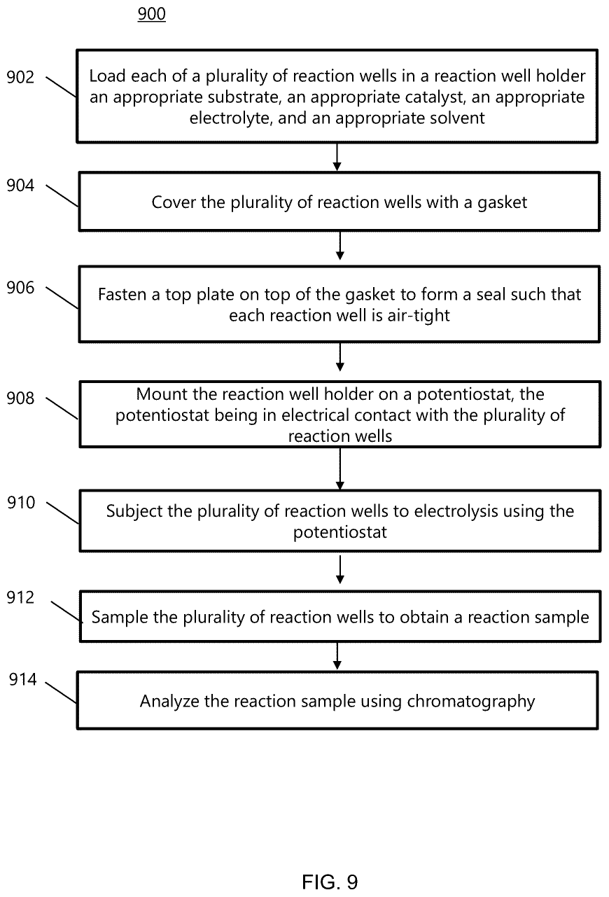

FIG. 8 depicts an example method 800 for electrochemical experimentation according to one or more embodiments described herein. FIG. 9 depicts an example flowchart 900 for a method for electrochemical experimentation and analysis according to one or more embodiments described herein. The method 800 and the flowchart 900 may be implemented by any suitable system or apparatus, such as the example device 100 and the potentiostat 200. In some embodiments, the device 100 may be used for various types of electrochemical experimentation, such as depicted in the method 800 and the flowchart 900. While an order of operations is indicated in FIGS. 8 and 9 for illustrative purposes, the timing and ordering of such operations may vary where appropriate without negating the purpose and advantages of the examples set forth in detail herein.

In step 902 and step 802, each of the plurality of reaction wells 20 in the reaction well holder 10 may be loaded with a substrate, a catalyst, a binder, an electrolyte and a solvent, or any combination thereof. In some embodiments, the substrate may be a conductive substrate. In some embodiments, the substrate may be a solid or liquid. In exemplary embodiments, the substrate may be a carbon containing conductive moiety such as carbon black, carbon nanotubes, C65, or activated carbon. In exemplary embodiments, the catalyst may be an organic or inorganic catalyst. In exemplary embodiments, the catalyst may be a transitional metal catalyst. In exemplary embodiments, the catalyst may combined with a binder and a solvent to create a catalyst solution. In exemplary embodiments, the binder may be a polymer. In exemplary embodiments, the binder may be a polymer selected from PVDF, polyethylene, or nafion. In exemplary embodiments, the solvent is a polar aprotic solvent. In exemplary embodiments, the solvent is water. In exemplary embodiments, the catalyst solution may be added by drop casting or slurry addition into each reaction well. In exemplary embodiments, the electrolyte is a soluble salt solution in either water or polar organic solvents. In exemplary embodiments, the electrolyte is selected from alkali metal carbonates, organic carbonates, alkali metal phosphates, alkali metal halides, and tetra-alkyl ammonium salts.

In step 904 and step 804, the openings 22 of the reaction wells 20 may be covered with the gasket 30. Following addition of the appropriate reagents, the reaction well holder may be enclosed by positioning a gasket on top of the plurality of reaction wells to cover the opening of each reaction well.

In step 906 and step 806, the top plate 50 may be fastened on top of the gasket 30 to form a seal. The device 100 may be assembled (for example, as shown in FIG. 6C) and ready for electrochemical experimentation. The top plate 50 may be positioned on top of the gasket 30 and fastened to the reaction well holder 10 to seal each reaction well 20. In exemplary embodiments, the each reaction well 20 may be sealed such that each reaction well 20 is air-tight. In some embodiments, the addition of reagents and enclosing of the reaction wells 20 may be performed under an inert atmosphere. In some embodiments, the reactions may be performed under an oxygen atmosphere.

In step 908 and step 808, the device 100 with the reaction well holder 10 may be mounted on the potentiostat 200, such that the potentiostat 200 is in electrical contact with the plurality of reaction wells 20 of the reaction well holder 10. The reaction well holder 10 may be mounted on the potentiostat 200 such that the plurality of electrical contacts 210 of the potentiostat 200 are in sufficient electrical contact with the plurality of electrical contacts 90 of the reaction well holder 10. In some embodiments, the reaction well holder 10 is mounted on the potentiostat 200 using the alignment member 110. In some embodiments, the reaction well holder 10 may be inserted within the alignment member 110 and then mounted on the potentiostat 200. In some embodiments, the alignment member 110 may be an alignment ring that fits snugly around the perimeter of the reaction well holder 10.

In step 910 and step 808, the plurality of reaction wells 20 may be subjected to electrolysis using the potentiostat 200. The device 100 for electrochemical experimentation may be subjected to electrolysis using the potentiostat 200. In some embodiments, the reaction wells 20 may be subjected to electrolysis in a sequential manner. As an example, each of the reaction wells 20 may be subjected to electrolysis sequentially in turn using the potentiostat 200. In some embodiments, the reaction wells 20 may be subjected to electrolysis in a parallel manner. As an example, two or more of the reaction wells 20 may be subjected to electrolysis sequentially simultaneously using the potentiostat 200. The electrolysis may be potentiostatic electrolysis or galvanostatic electrolysis. In some embodiments, the electrochemical profile of the reaction may be analyzed.

In step 912 and step 810, the plurality of reaction wells 20 may be sampled. In exemplary embodiments, each of the plurality of reaction wells 20 may be sampled to determine the status and outcome of the reaction. In some embodiments, the solution remaining in each reaction well 20 may be sampled to determine the outcome of the reaction. In exemplary embodiments, the headspace of each reaction well 20 may be sampled to determine the outcome of the reaction. In exemplary embodiments, each reaction well 20 may be sampled by extracting gases from each reaction well 20. In exemplary embodiments, the sampling of each reaction well 20 comprises piercing the gasket 30 with a needle 300 and sampling the headspace one of the reaction wells 20 to obtain a reaction sample. In exemplary embodiments, the reaction sample is a gas.

In step 914, each reaction sample may then be analyzed using a suitable analytical technique. In some embodiments, each reaction sample may be analyzed using nuclear magnetic resonance spectroscopy or an appropriate chromatography. In some embodiments, each reaction sample may be analyzed using gas chromatography or liquid chromatography. In exemplary embodiments, each reaction sample is analyzed using gas chromatography coupled with a mass spectrometer.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

Numerous modifications, alterations, and changes to the described embodiments are possible without departing from the scope of the present invention defined in the claims. It is intended that the present invention need not be limited to the described embodiments, but that it has the full scope defined by the language of the following claims, and equivalents thereof.

What is claimed is:

1. A device for electrochemical experimentation comprising:
a reaction well holder having a top surface and a bottom surface opposite the top surface, the reaction well holder comprising:
a plurality of reaction wells, each reaction well having an opening in the top surface of the reaction well holder and a bottom surface between the top surface and the bottom surface of the reaction well holder;
a plurality of electrodes in the reaction wells, each reaction well comprising two or more of the electrodes located on an interior side of the bottom surface of each reaction well; and
a plurality of electrical contacts located on the bottom surface of the reaction well holder, wherein, for each reaction well, two or more of the electrical contacts are in electrical communication with the two or more of the electrodes of the reaction well;
a gasket positioned on the top surface of the reaction well holder and covering the openings of the reaction wells; and
a top plate positioned on top of the gasket and fastened to the reaction well holder to create an airtight seal for the reaction wells.

2. The device of claim 1, wherein the plurality of reaction wells includes at least 40 reaction wells and at most 250 reaction wells.

3. The device of claim 1, wherein each reaction well has a volume of at least 0.2 milliliters to at most 5.0 milliliters.

4. The device of claim 1, wherein the electrodes are screen-printed electrodes.

5. The device of claim 1, wherein, for each reaction well, three of the electrical contacts are in electrical communication with three of the electrodes of the reaction well.

6. The device of claim 1, wherein the gasket is a silicone rubber gasket.

7. The device of claim 1, wherein the top plate is a stainless steel plate comprising a plurality of through holes aligned with the openings of the reaction wells.

8. The device of claim 1, wherein the reaction well holder further comprises:
an upper portion having a top surface and a bottom surface opposite the top surface, the top surface of the upper portion being the top surface of the reaction well holder, the upper portion comprising a plurality of through holes corresponding to the openings and interior side walls of the reaction wells; and
a lower portion having a top surface and a bottom surface opposite the top surface, the bottom surface of the lower portion being the bottom surface of the reaction well holder, the top surface of the lower portion comprising the plurality of electrodes of the reaction wells, the plurality of electrodes being a plurality of screen printed electrodes.

9. The device of claim 8, wherein the reaction well holder further comprises:
a plurality of alignment indicators to align the upper portion and the lower portion.

10. The device of claim 1, further comprising:
an alignment member to hold the device in place for alignment of the plurality of electrical contacts of the device located on the bottom surface of the reaction well holder with a corresponding plurality of electrical contacts of a potentiostat.

11. The device of claim 10, wherein the alignment member is an alignment ring configured to snugly fit around a perimeter of the reaction well holder.

12. The device of claim 10, wherein the alignment member has an open interior to receive the reaction well holder, and the open interior and has an area at least 50 cm² and at most 200 cm².

13. The device of claim 1, wherein the device is configured to be mounted on a potentiostat such that the plurality of electrical contacts of the device are aligned with a corresponding plurality of electrical contacts of the potentiostat.

14. A system for electrochemical analysis comprising:
the device for electrochemical experimentation of claim 13; and
the potentiostat.

15. A method for electrochemical experimentation comprising:
loading each of a plurality of reaction wells in a reaction well holder with a substrate, a catalyst, a binder, an electrolyte, and a solvent;
covering the plurality of reaction wells with a gasket;
fastening a top plate on top of the gasket to form a seal such that each reaction well is air-tight;
mounting the reaction well holder on a potentiostat, the potentiostat being in electrical contact with the plurality of reaction wells of the reaction well holder;
subjecting the plurality of reaction wells to electrolysis using the potentiostat; and
sampling the plurality of reaction wells.

16. The method of claim 15, wherein each of the plurality of reaction wells includes three electrodes in electrical contact with three corresponding electrical contacts of the potentiostat.

17. The method of claim 15, wherein the electrolysis is potentiostatic electrolysis or galvanostatic electrolysis.

18. The method of claim 15, wherein the plurality of reaction wells are sampled by extracting gases from the plurality of reaction wells.

19. The method of claim 15, wherein sampling the plurality of reaction wells comprises:
piercing the gasket with a needle; and
sampling a headspace of one of the reaction wells to obtain a reaction sample.

20. The method of claim 19, further comprising analyzing the reaction sample using chromatography.
